(19) United States
(12) Patent Application Publication
(10) Pub. No.: US 2024/0107991 A1
(43) Pub. Date: Apr. 4, 2024

(54) Fishing Lure Treble Hook Extractor Tool

(71) Applicant: Terry Pennell, Kerrville, TX (US)

(72) Inventor: Terry Pennell, Kerrville, TX (US)

(21) Appl. No.: 17/955,773

(22) Filed: Sep. 29, 2022

(51) Int. Cl. A01K 97/18

(52) U.S. Cl. CPC A01K 97/18

(57) ABSTRACT

A fishing lure treble hook extractor tool includes a handle with a first section and a second section displaced from the first section; and a head that extends from the second section, the head comprises an angled void.

### BACKGROUND

The present disclosure relates to fishing tool, and more specifically to a treble hook extractor tool.

Many sports fishermen release their caught fish. However, many fish species are very fragile and can be injured when removing the hooks, especially treble hooks. Barbless hooks have been used to ease the removal effort and to minimize injury to released fish. However, many fish may still die from exposure to air and extended handling during the hook removal process.

### SUMMARY

A fishing lure treble hook extractor tool according to one disclosed non-limiting embodiment of the present disclosure includes a handle with a first section and a second section displaced from the first section; and a head that extends from the second section, the head comprises an angled void.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1A-1J are views of a fishing lure treble hook extractor tool according to one disclosed non-limiting embodiment.

FIG. 2A-2J are views of a fishing lure treble hook extractor tool according to another disclosed non-limiting embodiment.

FIG. 3A-3E are views of the fishing lure treble hook extractor tool having captured a treble hook lure of various sizes

### DETAILED DESCRIPTION

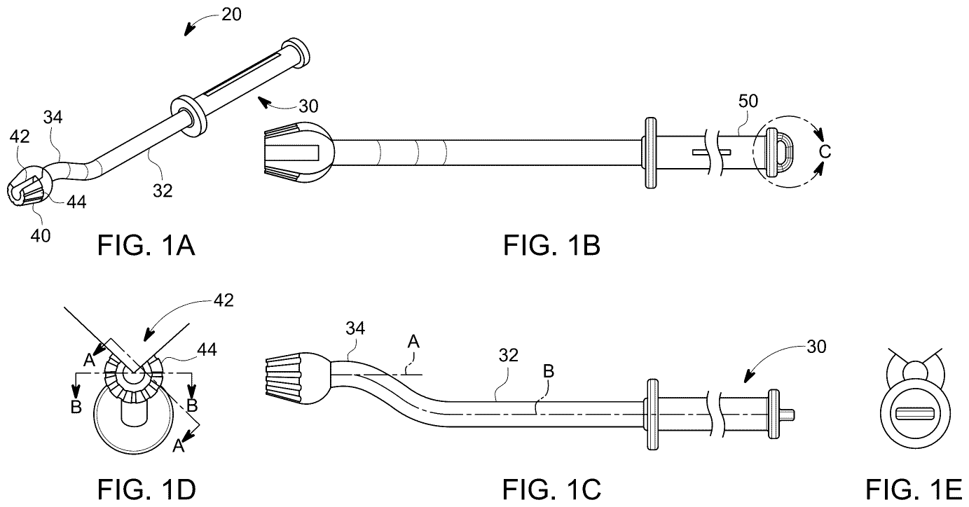

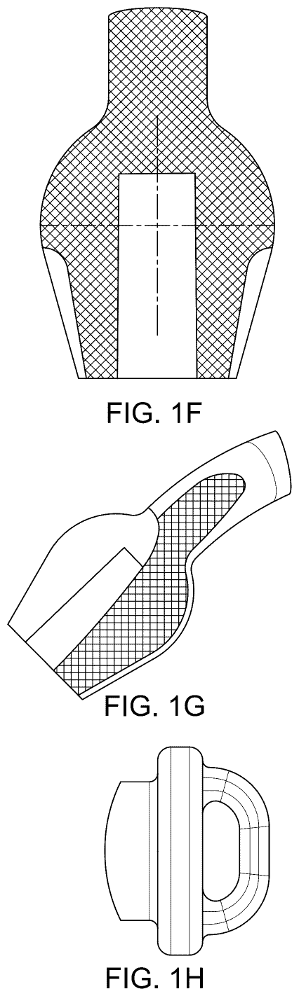

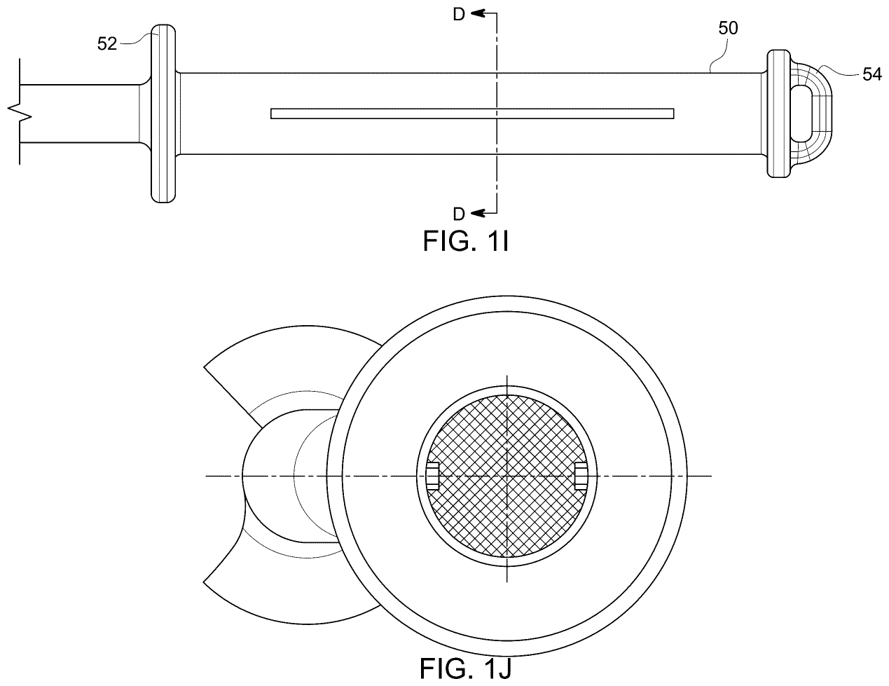

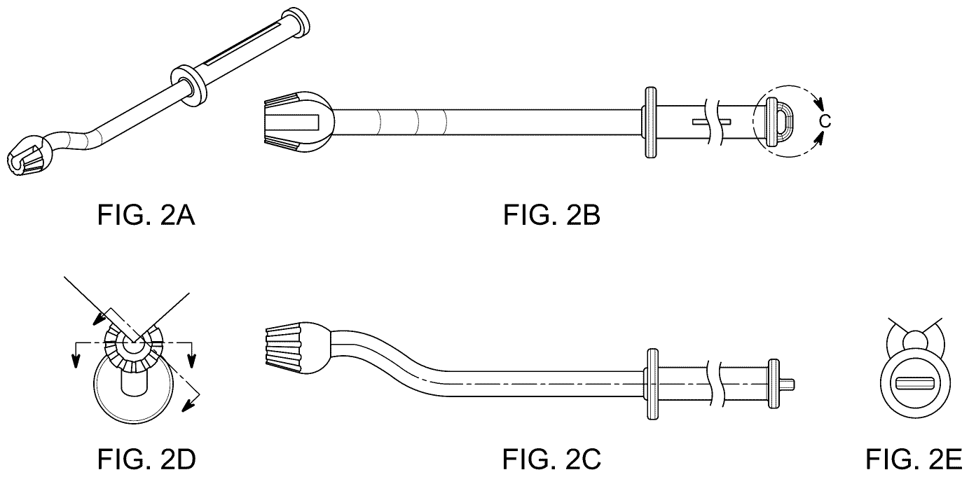

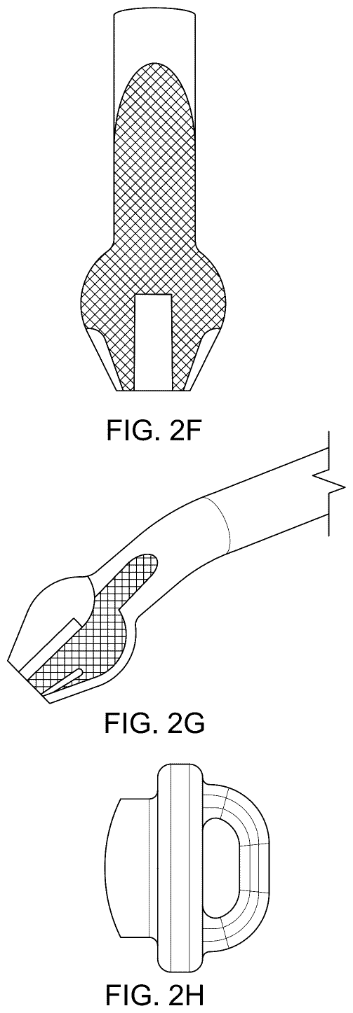

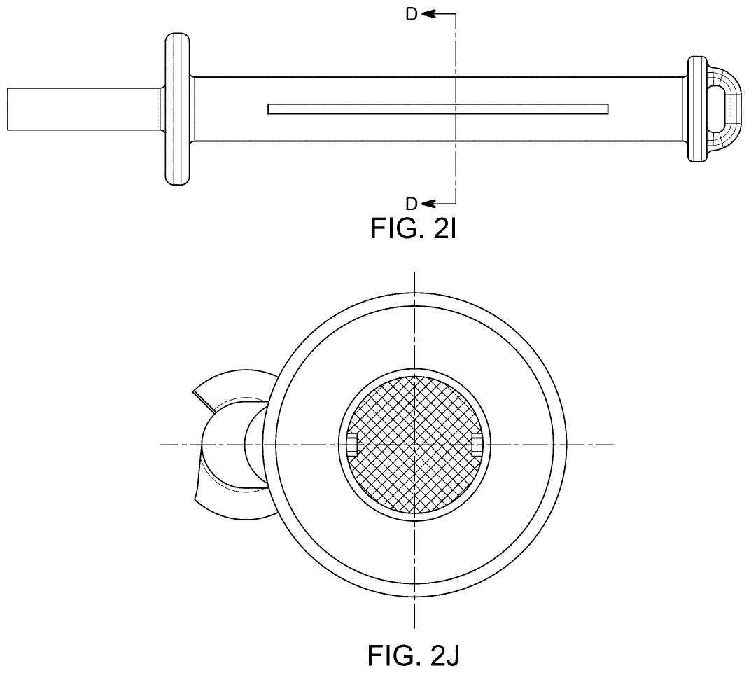

FIG. 1A-1J and FIG. 2A-2J schematically illustrates a fishing lure treble hook extractor tool 20 that is a hand-held tool which assists an angler or fishermen in the removal of a treble hook from a fish that is attached to a fishing lure. Treble hooks feature three bends and points in one hook. Trebles provide greater coverage for artificial baits such as crankbaits, jerkbaits or top water baits. Bait anglers also use trebles.

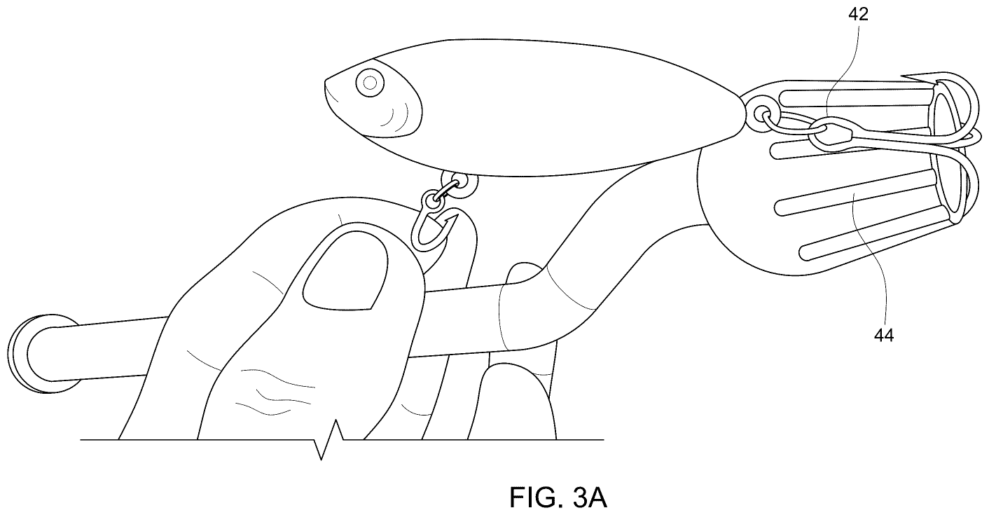

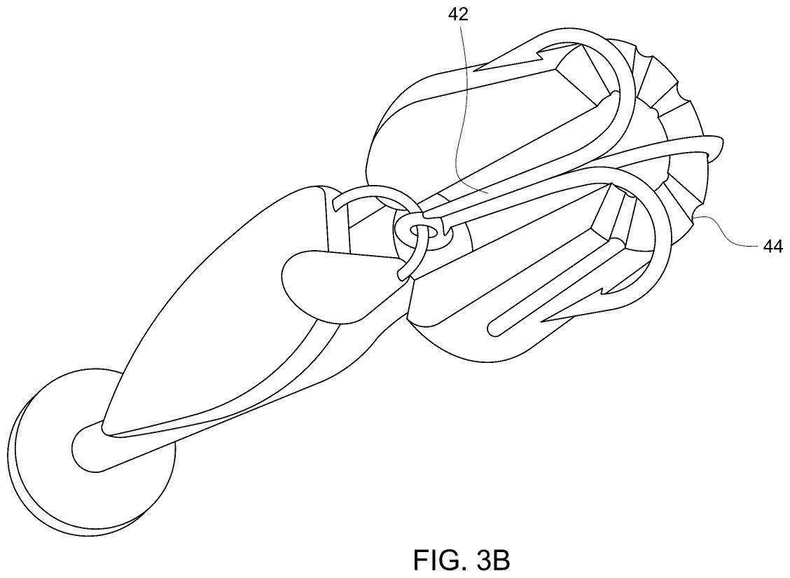

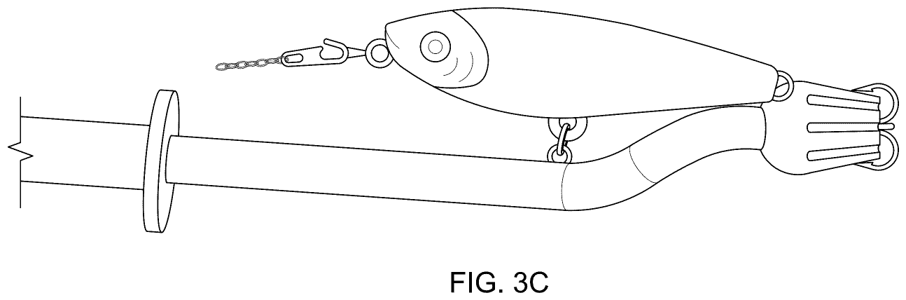

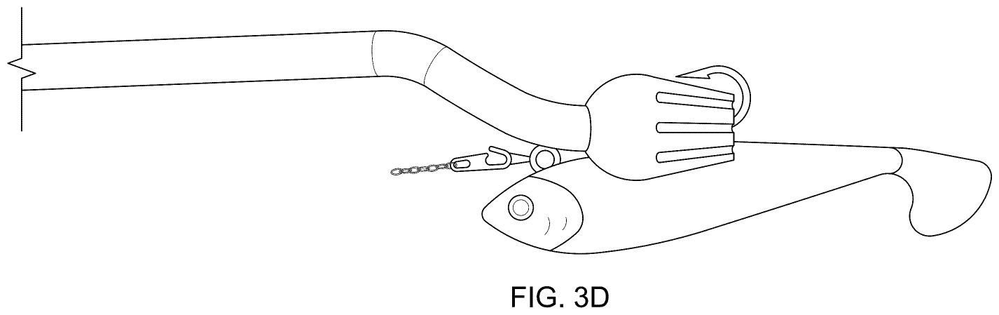

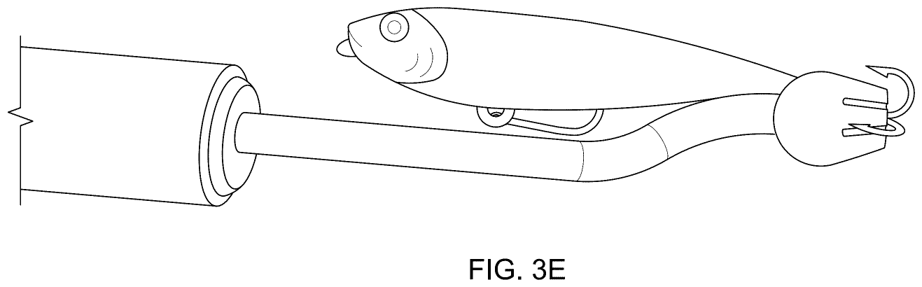

The fishing lure treble hook extractor tool 20 may be manufactured in multiple sizes. On size (FIG. 1A-1J) may for small to medium size Treble hooks (FIG. 3A-3B) and another (FIG. 2A-2 J) may be for medium to large treble hooks (FIG. 3C-3E) with the only primary difference being the size of the head.

The fishing lure treble hook extractor tool 20 generally includes a handle 30 from which extends a first section 32 and a second section 34 displaced from the first section 32. A head 40 extends from the second section 32. The head 40 may be larger diameter than the second section 32. The second section 34 is defined along an axis A in one embodiment that is parallel to the first section 32 that extends along axis B with bends therebetween (FIG. 1C).

The head 40 is generally tapered with a void 42 and a multiple of grooves 44 (FIG. 1D). The multiple of grooves 44 may each be separated by 30 degrees (FIG. 1D). The void 42 is angled to form a wedge shape and may form a wedged shaped void that is between 45-90 degrees. The void 42 may be displaced from the first section 32 in the same direction as the second section 34 (FIG. 1B). That is, the void 44 is the displaced from the first section 32 to essentially be on top of the second section 34. The void 44 eliminates interference from the lure body allowing for fast and easy treble hook extraction with minimal damage to the fish.

In one embodiment, the handle 30 may include a buoyant hand grip 50 (FIG. 11) which permits the tool to float if dropped in the water. The buoyant hand grip 50 may include a guard 52 and a pommel 54 that includes an aperture for attachment to a line or other retainer. The fishing lure treble hook extractor tool 20 may also be manufactured of bright colors to facilitate retrieval. Conventional treble hook removers are designed to remove a treble hook that is attached directly to a fishing line but cannot remove a treble hook that is connected to a fishing lure. The fishing lure treble hook extractor tool 20 requires little if any need for the fisherman to touch or even remove the fish from the water when removing a treble hook that is connected to a fishing lure. Thus, an extremely effective, quick and safe hook removal process is performed by the fishing lure treble hook extractor tool 20 that will result in little if any injury to the fish.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A fishing lure treble hook extractor tool, comprising:
a handle with a first section and a second section displaced from the first section; and
a head that extends from the second section, the head being at least partially a larger than the second section and comprises a void.

2. The tool as recited in claim 1, wherein the head is tapered.

3. The tool as recited in claim 1, wherein the head comprises a multiple of grooves.

4. The tool as recited in claim 3, wherein the multiple of grooves are each separated by 30 degrees.

5. The tool as recited in claim 1, wherein the second section is parallel to the first section.

6. The tool as recited in claim 1, wherein the void is angled to form a wedge shape.

7. The tool as recited in claim 1, wherein the void is angled at 45 degrees.

8. The tool as recited in claim 1, wherein the void is angled at 90 degrees.

9. The tool as recited in claim 1, wherein the void is displaced from the first section and the second section.

10. The tool as recited in claim 1, wherein the head is sized in accordance with the lure.

11. The tool as recited in claim 1, wherein the tool floats.
